(19) United States
(12) Patent Application Publication
(10) Pub. No.: US 2021/0200556 A1
(43) Pub. Date: Jul. 1, 2021

(54) BOOTING MODE CONFIGURATION METHOD, ELECTRONIC DEVICE AND COMPUTER PROGRAM PRODUCT

(71) Applicant: AMBIT MICROSYSTEMS (SHANGHAI) LTD., Shanghai (CN)

(72) Inventor: DA-JHENG LEE, New Taipei (TW)

(21) Appl. No.: 16/802,909

(22) Filed: Feb. 27, 2020

(30) Foreign Application Priority Data
Dec. 31, 2019 (CN) 201911406313.6

(51) Int. Cl. G06F 9/4401

(52) U.S. Cl. CPC G06F 9/4416

(57) ABSTRACT

A booting mode configuration method executable by an electronic device is disclosed. It is determined whether a configured booting mode is detected. If the configured booting mode is detected, a booting program corresponding to the configured booting mode is performed. If the configured booting mode is not detected, it is determined whether an access point is detected for connection. When the access point is detected, a satellite mode of the electronic device is configured and a booting program corresponding to the satellite mode is performed. When the access point is not detected and a wired connection is enabled, it is determined whether a PADO packet or a DHCP Offer packet is received to configure the electronic device as the satellite mode or a base mode, and a booting program corresponding to the satellite mode or the base mode is performed.

### BACKGROUND

### 1. Technical Field

The disclosure relates to configurations of computer devices, and more particularly to a booting mode configuration method and an electronic device using the method.

### 2. Description of Related Art

Wireless devices, such as Wi-Fi access points (AP), applied in a mesh network are popular. However, most of the wireless devices need to be configured as a satellite mode or a base mode when the wireless devices are activated for the first time. A method to rapidly configure mesh devices can greatly improve users' experience in setting up the wireless devices.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a flowchart of an embodiment of a booting mode configuration method of the present disclosure;

FIG. 2 is a block diagram of an embodiment of the hardware architecture of an electronic device using the method of the present disclosure; and

FIG. 3 is a schematic diagram of an embodiment of functional blocks of the electronic device using the method of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

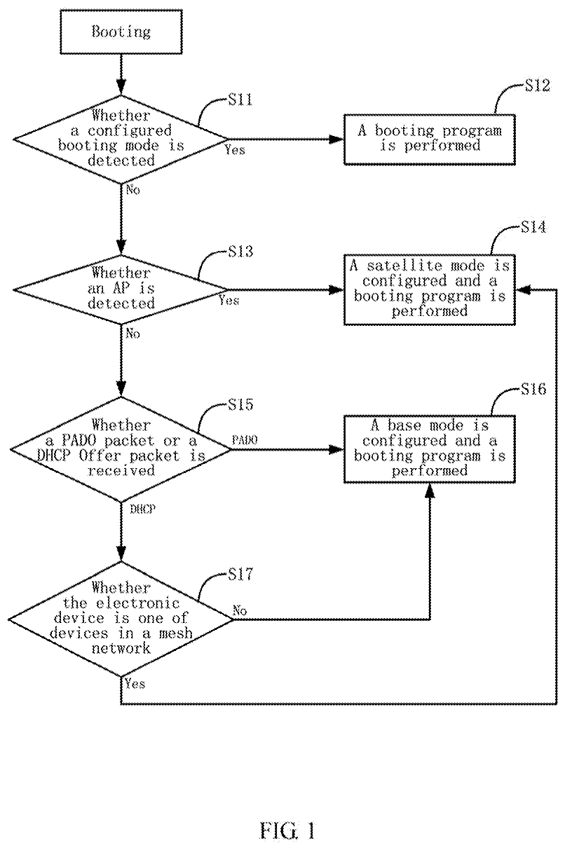

FIG. 1 is a flowchart of an embodiment of a booting mode configuration method of the present disclosure, executable by an electronic device. In block S11, it is determined whether a configured booting mode is detected. When the electronic device boots, if a device under test (DUT) determines that the electronic device has not been configured as a satellite mode or a base mode, the electronic device enters a default state. The default state is a temporary state indicating that the booting mode of the electronic device has not been defined. The default state provides functions comprising the Ethernet wide area network (WAN) and a wireless client interface, enabling a wired networking, via the Ethernet WAN, or a wireless networking of the electronic device. The Ethernet WAN implements port mapping to each of physical Ethernet ports for control and management.

When the electronic device boots, the daemon thereof performs a WAN detection program to monitor each of the Ethernet ports. The WAN detection program notifies a WAN detection module to perform a detection task while an Ethernet cable is plugged into one of the Ethernet ports. The WAN detection module works within a kernel space. The WAN detection program notifies the WAN detection module to generate a Dynamic Host Configuration Protocol (DHCP)/Point-to-Point Protocol over Ethernet (PPPoE) request to be used on detection. The WAN detection module then determines which network interface is enabled according to a response generated by the request.

After the detection is complete, the WAN detection module transmits the detecting result to the WAN detection program. As the detecting result is received, the WAN detection program re-generates a configuration profile according to the enabled network interface and the determined booting mode and then proceeds with the booting procedure. In an embodiment of the present disclosure, an Ethernet port corresponds to a network interface so that the blind mate function can be implemented.

In block S12, if the configured booting mode is detected, indicating a booting mode of the electronic device has not been configured, a booting program corresponding to the configured booting mode is performed.

In block S13, if the configured booting mode is not detected, it is determined whether an access point (AP) is detected for connection.

In block S14, when the access point is detected, a satellite mode of the electronic device is configured and a booting program corresponding to the satellite mode is performed.

In block S15, when the access point is not detected and a wired connection is enabled, it is determined whether a PPPoE Active Discovery Offer (PADO) packet or a DHCP Offer packet is received. The electronic device sends a PPPoE Active Discovery Initiation (PADI) packet and, in response to the PADI packet, when the PADO packet is received, creates a PPPoE connection.

In block S16, when the PADO packet is received, it is determined that the PPPoE connection is created, the base mode of the electronic device is configured and a booting program corresponding to the base mode is performed.

In block S17, when the DHCP Offer packet is received, it is then determined whether the electronic device is one of devices in a mesh network. The electronic device sends a DHCP request through the way that generates a pseudo media access control (MAC) address. If the DHCP Offer packet is received, the DHCP connection is confirmed. In addition, an option field in the DHCP Offer packet from a router in the mesh network is defined for determining whether the DHCP Offer packet comes from the router in the mesh network

If the electronic device is one of devices in the mesh network, the booting mode of the electronic device is configured as the satellite mode and the booting program corresponding to the satellite mode is performed (block S14). If the electronic device is not one of the devices in the mesh network, the booting mode of the electronic device is configured as the base mode and the booting program corresponding to the base mode is performed (block S16).

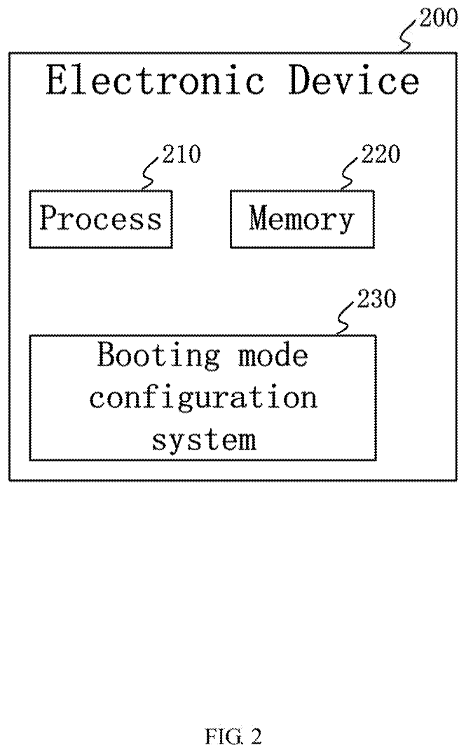

FIG. 2 is a block diagram of an embodiment of the hardware architecture of an electronic device using the method of the present disclosure. The electronic device 200 may, but is not limited to, connect to a processor 210, a memory 220 and a booting mode configuration system 230 via system buses. The electronic device 200 shown in FIG. 2 may include more or less components than those illustrated, or may combine certain components.

The memory 220 stores a computer program, such as the booting mode configuration system 230, which is executable by the processor 210. When the processor 210 executes the booting mode configuration system 230, the blocks in one embodiment of the booting mode configuration method applied in the electronic device 200 are implemented, such as blocks S11 to S17 shown in FIG. 1.

It will be understood by those skilled in the art that FIG. 2 is merely an example of the electronic device 200 and does not constitute a limitation to the electronic device 200. The electronic device 200 may include more or less components than those illustrated, or may combine certain components. The electronic device 200 may also include input and output devices, network access devices, buses, and the like.

The processor 210 may be a central processing unit (CPU), or may be other general-purpose processors, a digital signal processor (DSP), an application specific integrated circuit (ASIC), a Field-Programmable Gate Array (FPGA), or other programmable logic device, discrete gate or transistor logic device, discrete hardware components, or the like. The processor 210 may be a microprocessor or other processor known in the art.

The memory 220 can be used to store the booting mode configuration system 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or other volatile solid state storage device.

The booting mode configuration system 230 can be partitioned into one or more modules/units that are stored in the memory 220 and executed by the processor 210. The one or more modules/units may be a series of computer program instructions capable of performing particular functions of the booting mode configuration system 230.

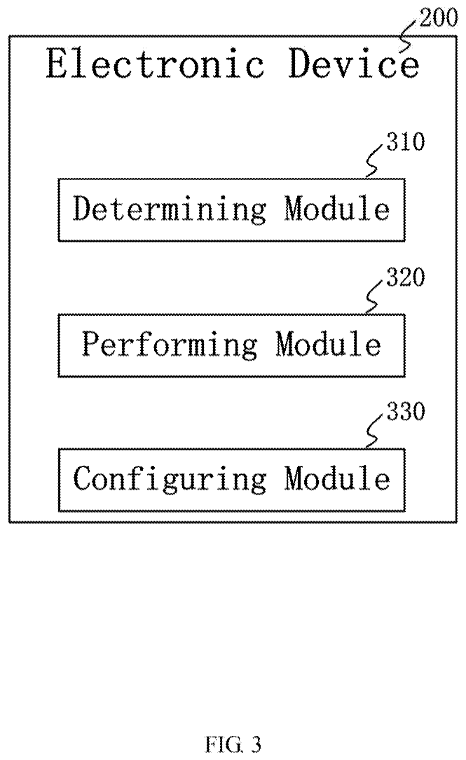

FIG. 3 is a schematic diagram of an embodiment of functional blocks of the electronic device using the method of the present disclosure.

The electronic device 200 comprises a determining module 310, a performing module 320 and a configuring module 330.

The configuring module 310 determines whether a configured booting mode is detected. When the electronic device 200 boots, if a DUT determines that the electronic device 200 has not been configured as a satellite mode or a base mode, the electronic device 200 enters a default state. The default state is a temporary state indicating that the booting mode of the electronic device 200 has not been defined. The default state provides functions comprising the Ethernet WAN and a wireless client interface, enabling a wired networking, via the Ethernet WAN, or a wireless networking of the electronic device. The Ethernet WAN implements port mapping to each of physical Ethernet ports for control and management.

When the electronic device 200 boots, the daemon thereof performs a WAN detection program to monitor each of the Ethernet ports. The WAN detection program notifies a WAN detection module (not shown) of the electronic device 200 to perform a detection task while an Ethernet cable is plugged into one of the Ethernet ports. The WAN detection module works within a kernel space. The WAN detection program notifies the WAN detection module to generate a DHCP)/PPPoE request to be used on detection. The WAN detection module then determines which network interface is enabled according to a response generated by the request.

After the detection is complete, the WAN detection module transmits the detecting result to the WAN detection program. As the detecting result is received, the WAN detection program re-generates a configuration profile according to the enabled network interface and the determined booting mode and then proceeds with the booting procedure. In an embodiment of the present disclosure, an Ethernet port corresponds to a network interface so that the blind mate function can be implemented.

If the configured booting mode is detected, indicating a booting mode of the electronic device 200 has not been configured, the performing module 320 performs a booting program corresponding to the configured booting mode.

If the configured booting mode is not detected, the determining module 310 determines whether an access point (AP) is detected for connection.

When the access point is detected, the configuring module 330 configures a satellite mode of the electronic device 200 and the performing module 320 performs a booting program corresponding to the satellite mode.

When the access point is not detected and a wired connection is enabled, the determining module 310 determines whether a PADO packet or a DHCP Offer packet is received. The electronic device 200 sends a PADI packet and, in response to the PADO packet, when the PADO packet is received, creates a PPPoE connection.

When the PADO packet is received, the determining module 310 determines that the PPPoE connection is created, the configuring module 330 configures the base mode of the electronic device 200 and the performing module 320 performs a booting program corresponding to the base mode.

When the DHCP Offer packet is received, the determining module 310 then determines whether the electronic device 200 is one of devices in a mesh network. The electronic device 200 sends a DHCP request through the way that generates a pseudo media access control (MAC) address. If the DHCP Offer packet is received, the DHCP connection is confirmed. In addition, an option field in the DHCP Offer packet from a router in the mesh network is defined for determining whether the DHCP Offer packet comes from the router in the mesh network

If the electronic device 200 is one of devices in the mesh network, the configuring module 330 configures the booting mode of the electronic device 200 as the satellite mode and the performing module 320 performs the booting program corresponding to the satellite mode. If the electronic device 200 is not one of the devices in the mesh network, the configuring module 330 configures the booting mode of the electronic device as the base mode and the performing module 320 performs the booting program corresponding to the base mode.

An embodiment of the booting mode configuration method is capable of detecting the WAN protocol and the Ethernet backhaul, enabling flexible and automatic configuration and provides plug and play function to the WAN/LAN ports.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A booting mode configuration method executable by an electronic device, comprising:
determining whether a configured booting mode is detected;
if the configured booting mode is detected, performing a booting program corresponding to the configured booting mode;
if the configured booting mode is not detected, determining whether an access point is detected for connection, wherein
when the access point is detected, configuring the electronic device as a satellite mode and performing a booting program corresponding to the satellite mode; and
when the access point is not detected and a wired connection is enabled, determining whether a PPPoE Active Discovery Offer (PADO) packet or a Dynamic Host Configuration Protocol (DHCP) Offer packet is received to configure the electronic device as the satellite mode or a base mode, and performing a booting program corresponding to the satellite mode or the base mode.

2. The method of claim 1, further comprising:
if the PADO packet is received and a Point-to-Point Protocol over Ethernet (PPPoE) connection is determined to be enabled according to the received PADO packet, configuring the electronic device as the base mode and performing a booting program corresponding to the base mode.

3. The method of claim 1, further comprising:
if the DHCP Offer packet is received, a DHCP connection is determined to be enabled according to the received DHCP Offer, determining whether the electronic device is one of a plurality of devices in a mesh network.

4. The method of claim 3, further comprising:
if the electronic device is determined to be one of the plurality of devices in the mesh network, configuring the electronic device as the satellite mode and performing the booting program corresponding to the satellite mode; and
if the electronic device is determined not one of the plurality of devices in the mesh network, configuring the electronic device as the base mode and performing the booting program corresponding to the base mode.

5. The method of claim 4, further comprising:
defining an option field in the DHCP Offer packet from a router in the mesh network and determining whether the DHCP Offer packet comes from the router in the mesh network according to the option field.

6. An electronic device, comprising:
a configuring module, configured to configuring a booting mode of the electronic device;
a determining module, configured to determine whether a configured booting mode is detected; and
a performing module, configured to perform a booting program corresponding to the configured booting mode if the configured booting mode is detected, wherein if the configured booting mode is not detected, the determining module further determines whether an access point is detected for connection;
when the access point is detected, the configuring module configures the electronic device as a satellite mode and the performing module performs a booting program corresponding to the satellite mode; and
when the access point is not detected and a wired connection is enabled, the determining module determines whether a PPPoE Active Discovery Offer (PADO) packet or a Dynamic Host Configuration Protocol (DHCP) Offer packet is received, the configuring module configures the electronic device as the satellite mode or a base mode according to the received PADO packet or the received DHCP Offer, respectively, and the performing module performs a booting program corresponding to the satellite mode or the base mode.

7. The device of claim 6, wherein: if the PADO packet is received, the determining module determines that a Point-to-Point Protocol over Ethernet (PPPoE) connection is enabled, the configuring module configures the electronic device as the base mode, and the performing module performs a booting program corresponding to the base mode.

8. The device of claim 6, wherein: if the DHCP Offer packet is received, the determining module determines that a DHCP connection is enabled and determines whether the electronic device is one of a plurality of devices in a mesh network.

9. The device of claim 8, wherein:
if the electronic device is determined to be one of the plurality of devices in the mesh network, the configuring module configures the electronic device as the satellite mode and the performing module performs the booting program corresponding to the satellite mode; and
if the electronic device is determined not one of the plurality of devices in the mesh network, the configuring module configures the electronic device as the base mode and the performing module performs the booting program corresponding to the base mode.

10. The device of claim 9, wherein the configuring module defines an option field in the DHCP Offer packet from a router in the mesh network for determining whether the DHCP Offer packet comes from the router in the mesh network.

11. A computer program product for execution on a booting mode configuration system, the computer program product comprising at least one non-transitory computer-readable medium having computer-readable program code portions embodied therein, the computer-readable program code portions comprising:
an executable portion configured to determine whether a configured booting mode is detected;
an executable portion configured to, if the configured booting mode is detected, perform a booting program corresponding to the configured booting mode;
an executable portion configured to, if the configured booting mode is not detected, determine whether an access point is detected for connection, wherein:
when the access point is detected, the electronic device is configured as a satellite mode and a booting program corresponding to the satellite mode is performed; and
when the access point is not detected and a wired connection is enabled, it is determined whether a PPPoE Active Discovery Offer (PADO) packet or a Dynamic Host Configuration Protocol (DHCP) Offer packet is received to configure the electronic device as the satellite mode or a base mode, and a booting program corresponding to the satellite mode or the base mode is performed.

12. The computer program product of claim 11, wherein the computer-readable program code portions further comprises:
an executable portion configured to, if the PADO packet is received and a Point-to-Point Protocol over Ethernet (PPPoE) connection is determined to be enabled according to the received PADO packet, configure the electronic device as the base mode and perform a booting program corresponding to the base mode.

13. The computer program product of claim 11, the computer-readable program code portions further comprises:
an executable portion configured to, if the DHCP Offer packet is received a DHCP connection is determined to be enabled according to the received DHCP Offer, determine whether the electronic device is one of a plurality of devices in a mesh network.

14. The computer program product of claim 13, wherein the computer-readable program code portions further comprises:
an executable portion configured to, if the electronic device is determined to be one of the plurality of devices in the mesh network, configure the electronic device as the satellite mode and perform the booting program corresponding to the satellite mode; and
an executable portion configured to, if the electronic device is determined not one of the plurality of devices in the mesh network, configure the electronic device as the base mode and performs the booting program corresponding to the base mode.

15. The computer program product of claim 14, wherein the computer-readable program code portions further comprises:
an executable portion configured to define an option field in the DHCP Offer packet from a router in the mesh network and determine whether the DHCP Offer packet comes from the router in the mesh network according to the option field.
